(19) United States
(12) Patent Application Publication
(10) Pub. No.: US 2023/0292712 A1
(43) Pub. Date: Sep. 21, 2023

(54) PET TOY

(71) Applicant: Doskocil Manufacturing Company, Inc., Arlington, TX (US)

(72) Inventors: Josiah WILHELM, Arlington, TX (US); Ron BAGLEY, Arlington, TX (US); Sunil PINTO, Arlington, TX (US)

(21) Appl. No.: 18/124,162

(22) Filed: Mar. 21, 2023

Related U.S. Application Data
(60) Provisional application No. 63/322,073, filed on Mar. 21, 2022.

(51) Int. Cl. A01K 15/02

(52) U.S. Cl. CPC A01K 15/025

(57) ABSTRACT

A pet toy includes a base, a stem, a reservoir and a fluid emitter. The base has an arcuate shaped bottom. The stem extends from a top of the base. The reservoir is housed in the base. The fluid emitter is in fluid connection with the reservoir. The fluid emitter emits fluid from the reservoir to be expelled from an outlet located at the top of the base.

### CROSS-REFERENCE TO RELATED APPLICATIONS

This application claims priority to Provisional U.S. Patent Application No. 63/322,073, filed on Mar. 21, 2022. The entire disclosure of Provisional U.S. Patent Application No. 63/322,073 is hereby incorporated herein by reference.

### BACKGROUND

### Field of the Invention

The present disclosure generally relates to a pet toy. More specifically, the present disclosure relates to a pet toy that generates automatic positive reinforcement during play.

### Background Information

Pet toys can be designed to have an eye catching component, such as feathers and bright colored string, while also containing an electronic feedback mechanism that can provide positive reinforcement to the pet to constantly reengage the toy during play.

### SUMMARY

It has been determined that an improved pet toy that can increase a pet's engagement with the toy is desired. In view of the state of the known technology, one aspect of the present disclosure is to provide a pet toy capable of providing positive feedback to the pet automatically during play so to maintain the pet's engagement. Therefore, one aspect of the present disclosure is to provide a pet toy comprising a base, a stem, a reservoir and a fluid emitter. The base has an arcuate shaped bottom. The stem extends from a top of the base. The reservoir is housed in the base. The fluid emitter is in fluid connection with the reservoir. The fluid emitter emits fluid from the reservoir to be expelled from an outlet located at the top of the base.

This improved pet toy can increase pet enjoyment using asymmetric automatic feedback which can further prolong pet engagement with the toy.

### BRIEF DESCRIPTION OF THE DRAWINGS

Referring now to the attached drawings which form a part of this original disclosure:

FIG. 1 is a perspective view of a pet toy in accordance with an illustrated embodiment;

FIG. 2 is a perspective view of the pet toy without a toy topper;

FIG. 3 is an enlarged perspective view of an elongated stem and a portion of a base of the pet toy;

FIG. 4 is a bottom perspective view of the pet toy without the toy topper;

FIG. 5 is a top plan view of the pet toy;

FIG. 6 is a bottom plan view of the pet toy;

FIG. 7 is a top exploded view of the pet toy;

FIG. 8 is a bottom exploded view of the pet toy;

FIG. 9 is a cross-sectional view of the base of the pet toy;

FIG. 10 is a portion of the interior of the base of the pet toy;

FIG. 11 is portion of the interior of the base of FIG. 10 but further including an electronic module;

FIG. 12 is a top plan view of the base of FIG. 11;

FIG. 13 is a perspective view of a portion of the bottom of the base showing a compartment for a reservoir;

FIG. 14 is a top perspective view of a reservoir of the pet toy;

FIG. 15 is a perspective view of a modified pet toy pet toy;

FIG. 16 is a cross-sectional view of a base of the modified pet toy; and

FIG. 17 is another cross-sectional view of the base of the modified pet toy.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

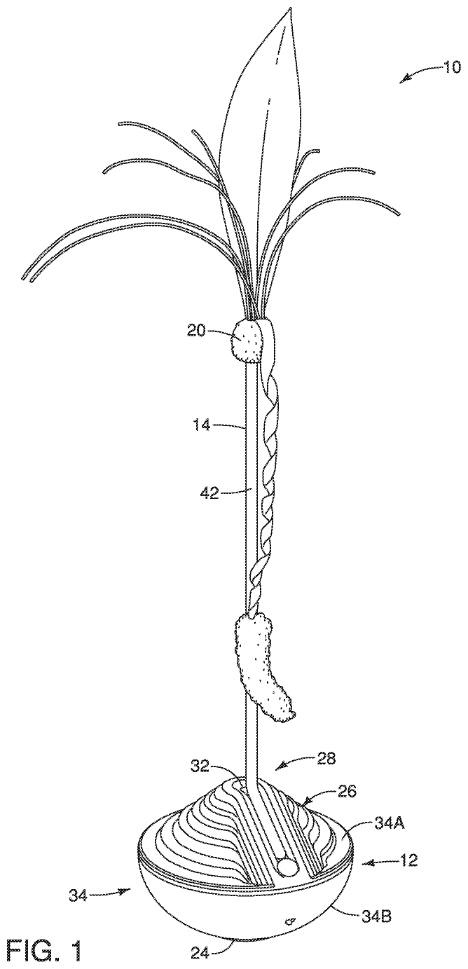

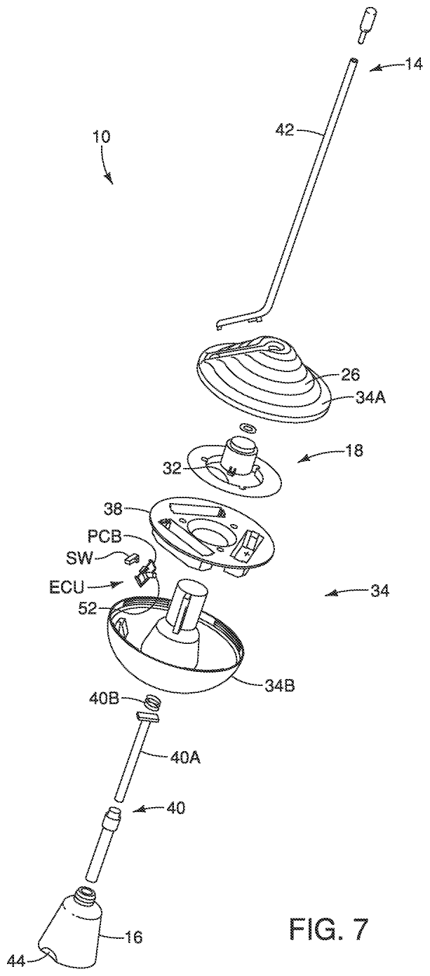

Referring to FIGS. 1 to 3, a pet toy 10 is illustrated in accordance with an illustrated embodiment. The pet toy 10 comprises a base 12, a stem 14 and a reservoir 16. The pet toy 10 of the illustrated embodiment further comprises a fluid emitter 18. See for example, FIG. 7. The reservoir 16 is configured to store fluid, such as catnip spray that can be automatically emitted by the fluid emitter 18 during a pet's engagement with the pet toy 10, As seen in FIG. 1, the pet toy 10 further comprises a toy topper 20 that is detachably fixed to an end of the stem 14. The toy topper 20 of the illustrated embodiment can be a whack toy or a string toy for cats. The toy topper 20 is provided to entice the pet to swipe at the toy topper 20 which causes the base 12 of the pet toy 10 to wobble.

In the illustrated embodiment, the fluid emitter 18 is configured to automatically emit fluid from the reservoir 16 (e.g., catnip mist) when the base 12 wobbles. The emission of the catnip mist is a positive reward for the cat which reinforces their interest and extends their engagement with the pet toy 10. In other words, emission of the catnip mist is triggered by active play or engagement with the pet toy 10. Therefore, the pet toy 10 of the illustrated embodiment provides cats a new way to play by combining traditional play toys (e.g., the toy topper 20) with a reward (e.g., catnip mist). As stated, the fluid emitter 18 automatically emits catnip mist when the pet toy 10 is engaged (e.g., the base 12 wobbles or rocks back and forth). Therefore, the pet toy 10 of the illustrated embodiment includes a motion sensor 52 to detect movement of the pet toy 10, as will be further discussed. Thus, the pet toy 10 is a motion sensing wobble toy that defuses catnip oil to attract or engage pets. The pet's engagement with the toy activates emission by the fluid emitter 18.

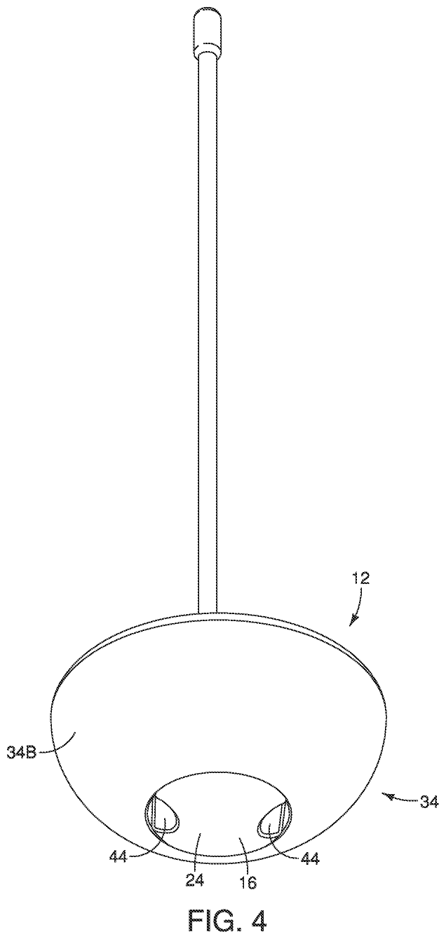

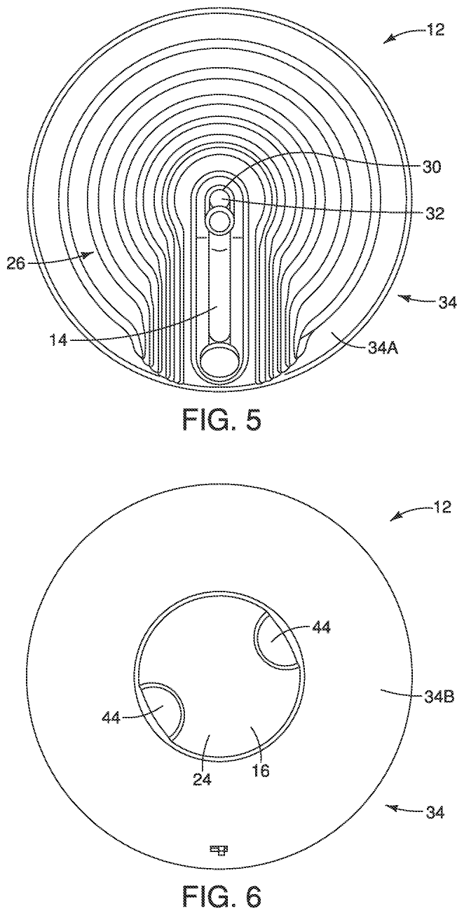

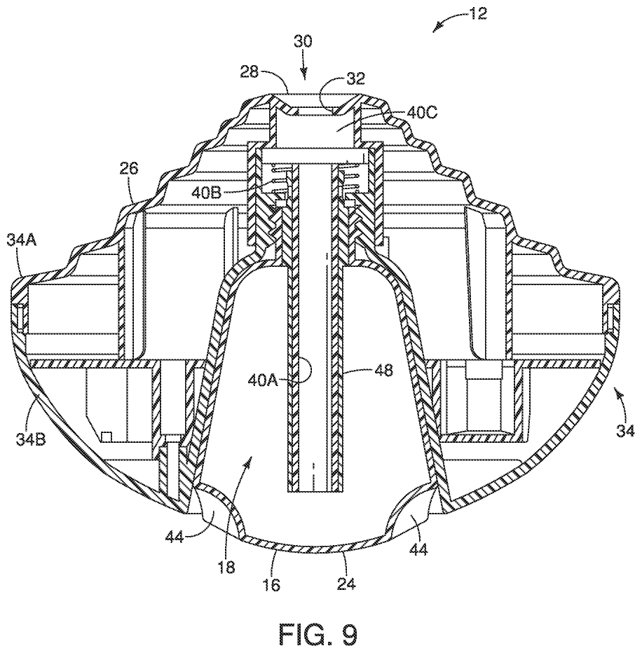

As best seen in FIG. 4, the base 12 has an arcuate shaped bottom. Alternatively speaking, the base 12 has a rounded bottom surface 24 that enables the base 12 to wobble during play. The bottom of the base 12 is also partially defined by the reservoir 16, as will be further discussed below. As shown in FIG. 5, the base 12 includes a plurality of ridges 26 disposed between the arcuate bottom and a top 28 of the base 12, The ridges 26 preferably have textured surfaces that will entice the pet to rub against the ridges 26. The ridges 26 preferably have a gradually decreasing circumference from the base 12 to a top 28 of the base 12. As best seen in FIGS. 3 and 9, the base 12 has a tip 30 formed at the top 28 of the base 12. As shown, the tip 30 includes an opening that is an outlet 32 for the fluid emitter 18. The fluid emitter 18 emits catnip spray from the outlet 32 during play, as will be further discussed below.

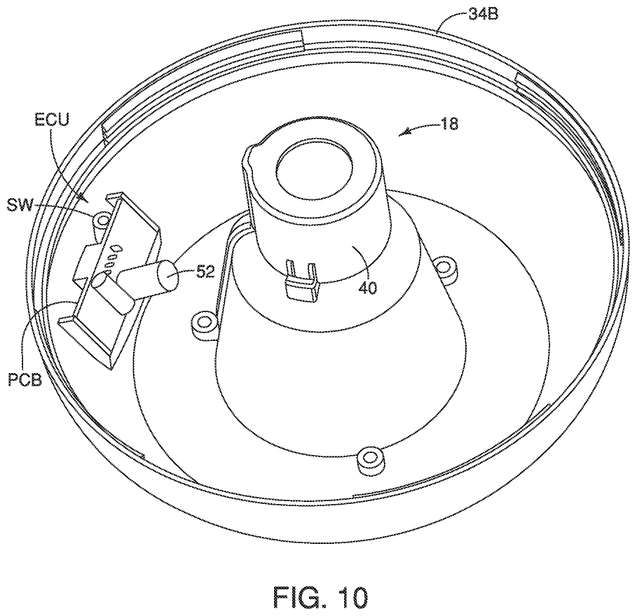

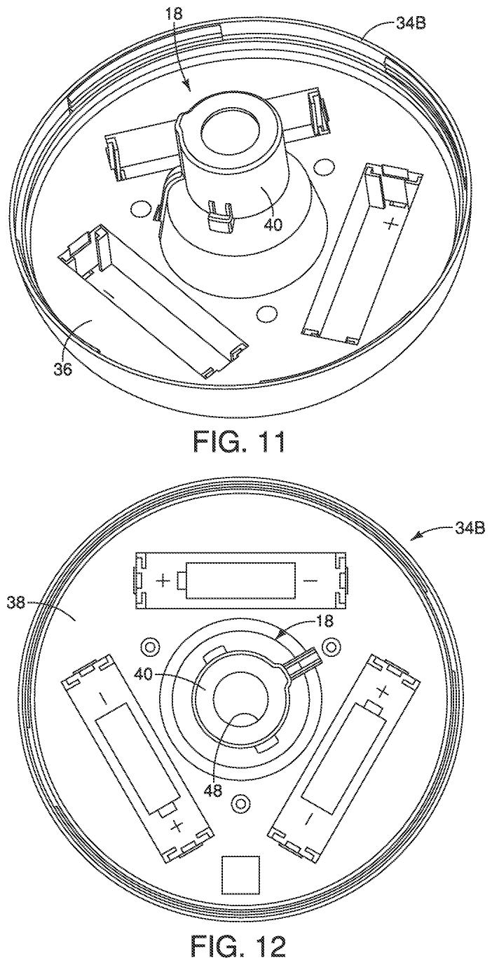

Referring to FIGS. 7 and 9, the base 12 forms a housing 34 for the reservoir 16 and the fluid emitter 18. The pet toy 10 further includes a battery module 36 that powers an electronic module 38 of the pet toy 10. The base 12 also houses the battery module 36 and the electronic module 38, as best seen in FIGS. 10 to 12. The base 12 includes a first (top) pan 28 and a second (bottom) part that are fixed to each other to define the housing 34 for the other components of the pet toy 10. Preferably, the top and bottom parts 34A and 34B of the base 12 are threaded to each other. The top and bottom parts 34A and 34B of the base 12 are preferably made of ABS plastic (i.e., acrylonitrile butadiene styrene.

As seen in FIGS. 1 to 3, the stem 14 is supported to the top part 28 of the base 12. In particular, the stem 14 is supported to the top part 28 at a location that is adjacent to the outlet 32. The top part 28 includes the outlet 32 for the fluid emitter 18. The top part 28 also includes the plurality of ridges 26 that are textured. Referring to FIGS. 6 to 8, the reservoir 16 is supported to the bottom part 34B of the base 12. As seen in FIG. 9, the top and bottom parts 34A and 34B are fitted together to form a channel 48 that enables fluid communication between the reservoir 16 and the outlet 32. The fluid emitter 18 includes a emitting portion 40 that is supported in the channel 48. The emitting portion 40 extends from the outlet 32 to the reservoir 16 to emitting portion 40 catnip mist from the reservoir 16 to the outlet 32. Therefore, the reservoir 16 and the outlet 32 are in fluid communication via the emitting portion 40.

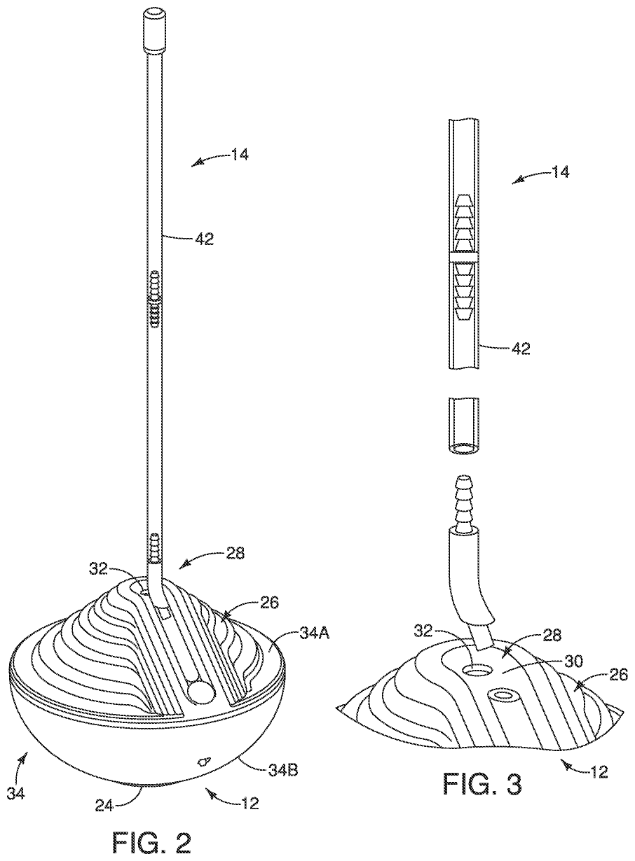

The stem 14 extends from the top of the base 12. The stem 14 has an elongated body 42 that is detachably fixed to the base 12 at a location adjacent to the outlet 32. As best seen in FIGS. 2 and 3, the stem 14 is detachably attached to the base 12 by snap-fit. Thus, the stem 14 is readily removable from the base 12 by a user for convenient storage of the pet toy 10. The stem 14 is preferably formed from plastic, such as polyvinyl chloride (PVC). More preferably, the stem 14 is a PVC tube comprising one or more tubes that are installed to each other, as seen in FIGS. 2 and 3. As shown, the stem 14 preferably includes one or more elongated bodies that can be press-fitted to each other. The stem 14 preferably further includes a connector that is snap-fined to the base 12 so to support the elongated bodies. The elongated bodies are press-fitted to the connector which is then snap-fitted to the base 12.

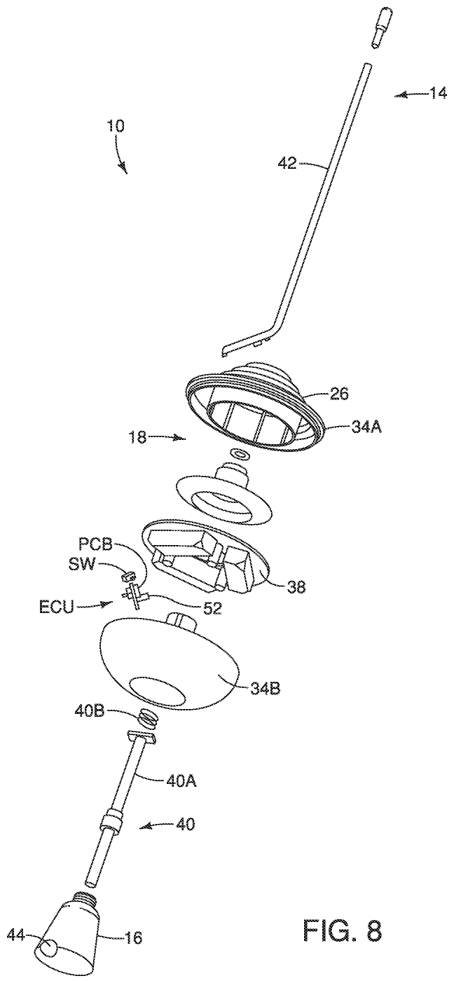

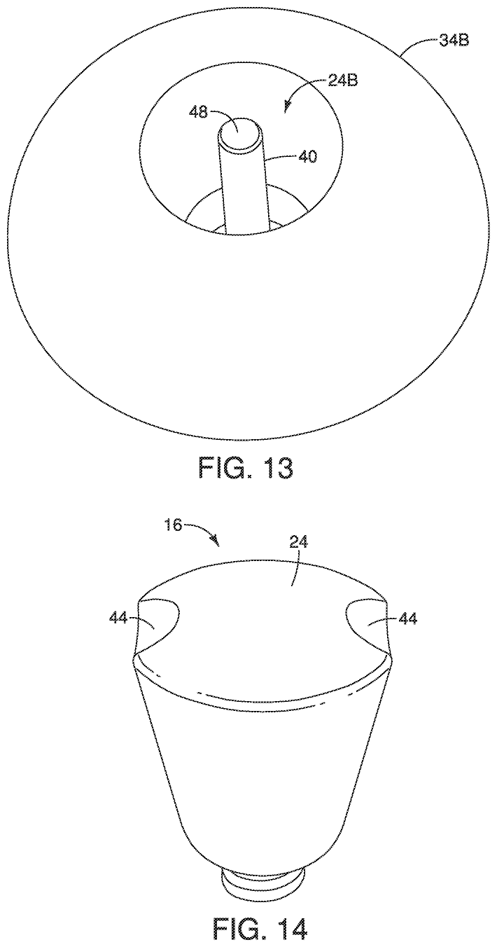

Referring to FIGS. 7 to 8, the reservoir 16 is housed in the base 12. The bottom part 34B of the base 12 includes a compartment 24B that receives the reservoir 16 therethrough, as seen in FIG. 13. The reservoir 16 is threaded to the second part of the base 12 to be secured therein. The reservoir 16 is removably attached to the base 12 at the arcuate shaped bottom. Therefore, the reservoir 16 has an arcuate shaped surface that aligns flush with the acuate shaped bottom surface 24 of the base 12. The reservoir 16 partially defines the bottom of the pet toy 10. The reservoir 16 preferably includes a pair of user operating surfaces 44 to enable the user to thread and unthread the reservoir 16 from the base 12. Therefore, the reservoir 16 is detachably attached to the base 12 to enable the user to refill the reservoir 16 with catnip mist as needed. The reservoir 16 has an opening that receives the emitting portion 40 therethrough.

Therefore, the fluid emitter 18 is in fluid connection with the reservoir 16 by the emitting portion 40. The emitting portion 40 pumps fluid from the reservoir 16 to be expelled from the outlet 32 that is located at the top of the base 12. As shown, in FIG. 9, the emitting portion 40 preferably includes a tube 40A, a spring 40B and an atomizer spray 40C positioned near the outlet 32.

The emitting portion 40 of the fluid emitter 18 is preferably automatically triggered to begin activating (i.e., pumping fluid). The emitting portion 40 is triggered by motion detected by the motion sensor 52. In the illustrated embodiment, the emitting portion 40 can act similar to a pump or atomizer on a perfume bottle or other similar type of spraying device.

As seen in FIG. 9, the emitting portion 40 comprises of a plastic tube 40A that draws fluid from the bottom of the reservoir 16. The tube 40A is preferably in electronic communication with the electronic controller ECU to be activated by the electronic controller ECU during play. The motion sensor 52 detecting motion or engagement to the pet toy 10 automatically activates the emitting portion 40. The tribe 40A is housed in the cylinder that houses the spring 40B, During operation, the tube 40A moves with respect to the bottom part 34B to compress the spring 40B to cause pumping. The fluid emitter 18 can further include a one-way valve (not shown) between the emitting portion 40 and the reservoir 16 to prevent back flow of the catnip mist back into the reservoir 16, The fluid emitter 18 preferably further includes an electronic switch SW in electrical connection with the electronic controller ECU to activate the fluid emitter 18. That is, the user can turn the fluid emitter 18 ON and OFF via the electronic switch SW as desired.

As seen in FIG. 1, the toy topper 20 is attached to the top of the stem 14, preferably by snap-fit or press-fit. As shown, the toy topper 20 is preferably a colorful toy having eye-catching components, such as feathers, plush and a ribbon. The toy topper 20 therefore at least includes fabric. The toy topper 20 provides different visual and textural enticements to the pet to engage with the pet toy 10, Preferably, the pet will swipe or nip at the toy topper 20 to cause the base 12 to wobble and to activate the fluid emitter 18.

As stated, the electronic controller ECU controls the fluid emitter 18 to emit fluid upon the motion sensor 52 detecting a predetermined motion threshold to the pet toy 10. For example, the electronic controller ECU can send an electronic signal to the emitting portion 40 to begin pumping upon the motion sensor 52 sensing that the pet toy 10 is tilting. Therefore, the electronic controller ECU activates the emitting portion 40 to pump fluid from the reservoir 16 to the outlet 32 upon the motion sensor 52 detecting the predetermined motion threshold.

The electronic controller ECU preferably includes a printed circuit board PCB that is in electric communication with the motion sensor 52, as seen in FIGS. 10 to 12. The printed circuit board PCB can be equipped with a circuit of resistors and capacitors as needed. The motion sensor 52 can be an accelerometer or a gyroscope. The motion sensor 52 can alternatively be an offset weight detector that can send an activation signal upon the weight being unbalanced.

Therefore, the electronic module 38 further comprises the electronic controller ECU that is in electronic communication that with the motion sensor 52. When the motion sensor 52 detects that the pet toy 10 is rocking or wobbling, the electronic module 38 activates the emitting portion 40 to emit catnip mist. The emitting portion 40 is activated from a rest state to an operated state upon the motion sensor 52 detecting a predetermined threshold movement of the pet toy 10. The electronic controller ECU can include memory that is prestored with the predetermined threshold.

While the pet toy 10 is configured to emit catnip mist during the period in which the base 12 is wobbling, it will also be apparent to those skilled in the pet product field from this disclosure that the pet toy 10 can emit catnip mist base 12d on predetermined periods. Therefore, the electronic controller ECU can be programmed with a timer to control of the emitting portion 40. The timer can be in electronic communication with the electronic controller ECU. The electronic controller ECU activates the emitting portion 40 between the activated state and the rest state base 12d on predetermined time lengths determined by the timer. For example, electronic controller ECU can control the emitting portion 40 to emitting portion 40 fluid for a predetermined activation time. The electronic controller ECU can control the emitting portion 40 to not emitting portion 40 fluid for a predetermined length of time after the emitting portion 40 had just been activated, thus preventing immediate reactivation of the emitting portion 40 during a reset time.

The electronic controller ECU preferably includes a microcomputer with a fluid emitter 18 control program that controls the emitting portion 40 of the fluid emitter 18 as discussed above. The electronic controller ECU can also include other conventional components such as an input interface circuit, an output interface circuit, and storage devices such as a ROM (Read. Only Memory) device and a RAM (Random Access Memory) device. The microcomputer of the electronic controller ECU is programmed to control the emitting portion 40, the timer and the motion sensor 52. The memory circuit stores processing results and control programs such as the emitting portion 40 operation that are run by the processor circuit. The internal RAM of the electronic controller ECU stores statuses of operational flags and various control data. The internal ROM of the electronic controller ECU stores the predetermined time lengths and predetermined motion level for various operations. The electronic controller ECU is capable of selectively controlling any of the components of the control system 14 in accordance with the control program. It will be apparent to those skilled in the art from this disclosure that the precise structure and algorithms for the electronic controller ECU can be any combination of hardware and software that will carry out the functions of the present invention.

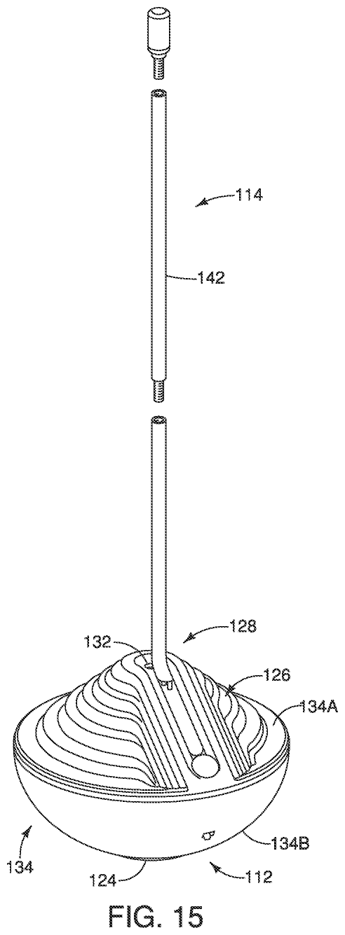

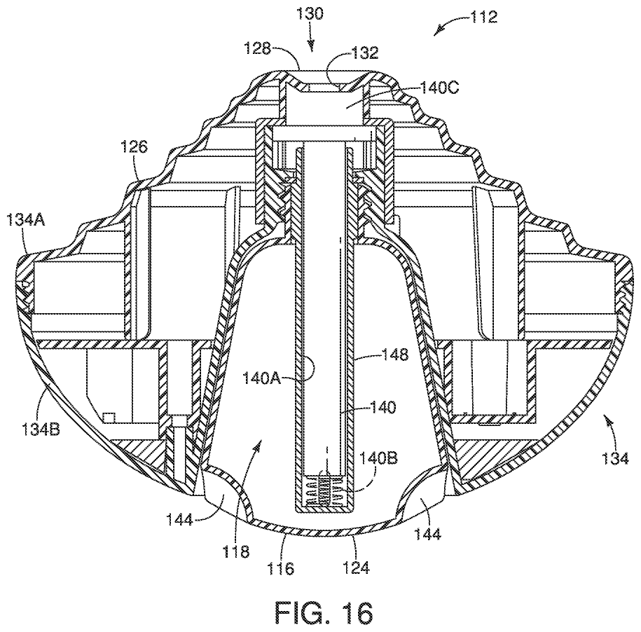

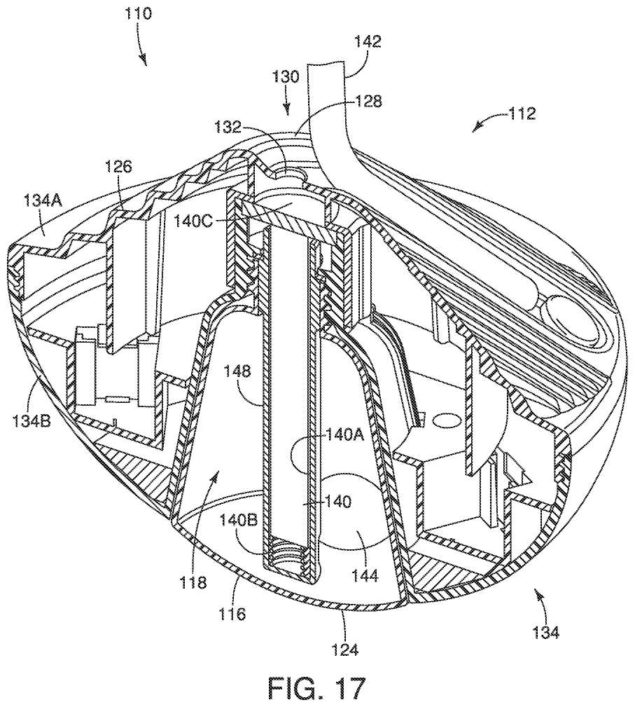

Referring now to FIGS. 15 to 17, a portion of a modified pet toy 110 is illustrated in accordance with an embodiment. The modified pet toy 110 is substantially identical to the pet toy 10 of FIGS. 1 to 14. Due to the similarities between the modified pet toy 110 and the pet toy 10, corresponding components of the modified pet toy 110 will receive the same reference numerals as the pet toy 10 but increased by 100. The modified pet toy 110 includes a modified stem 114 that is detachably attached to the modified base 112. The modified stem 112 includes attachment structures such as a hook and attachment protrusions that are snap hooks that are detachably fitted to the base 112.

The modified pet toy 110 is identical to the pet toy 10 of FIGS. 1 to 15, except that the modified pet toy 110 includes a modified spring 140B that biases a modified tube 140A. The modified spring 140B is provided at a bottom of the modified tube 140A to bias the modified tube 140a. Due to the similarities between the modified pet toy 110 and the pet toy 10, a corresponding components of the modified pet toy 110 will have the same reference numerals as the pet toy 10 except increased by 100.

The modified pet toy 110 includes a modified channel 148 that forms a housing for the modified tube 140A. The modified channel 148 includes a second reservoir R that contains the spring 150. The second reservoir R is defined by a space between the bottom of the modified tube 140A and the bottom of the modified channel 148. The second reservoir R includes an opening 150 that enables fluid to enter from the reservoir 116 into the second reservoir R. The opening 150 is a hole through a portion of the wall of the modified channel 148. The modified channel 148 includes a modified emitting portion 140 that accesses the fluid that enters into opening 150 from the reservoir R therethrough so that it can be emitted by the modified pet toy 110. Fluid continuously enters through the opening 150 from the reservoir 116 into the second reservoir R. Therefore, the modified tube 140A continuously has access to fluid during operation.

In the illustrated embodiment, the modified emitting portion 140 is a cotton fiber stick. The modified emitting portion 140 can be made from reinforced nonwoven cotton fiber with either aluminum oxide or silicon carbide abrasives which are pressed and bonded together into different profile shapes and sizes. The modified emitting portion 140 transfers fluid from the reservoir to be emitted from the base 112.

The modified pet toy 110 can include an electronic controller ECU that activates automatic emission in the same way as that described for the pet toy 10. The modified pet toy 110 can include a piezo vibration generator that vibrates at a rate fast enough to cause fluid absorbed by the modified emitting portion 140 to mist up and out of the base 112.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the pet toy. Accordingly, these terms, as utilized to describe the present invention should be interpreted relative to the pet toy.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy, comprising:
a base having an arcuate shaped bottom;
a stem extending from a top of the base;
a reservoir housed in the base; and
a fluid emitter in fluid connection with the reservoir, the fluid emitter emitting fluid from the reservoir to be expelled from an outlet located at the top of the base.

2. The pet toy according to claim 1, further comprising
a toy topper that is detachably fixed to an end of the stem, the toy topper containing fabric.

3. The pet toy according to claim 2, further comprising
an electronic controller and a motion sensor, the electronic controller controlling the fluid emitter to emit fluid upon the motion sensor detecting a predetermined motion threshold provided to the pet toy.

4. The pet toy according to claim 3, wherein
the fluid emitter includes an emitting portion extending from the reservoir to the outlet.

5. The pet toy according to claim 4, wherein
the electronic controller activates the emitting portion upon the motion sensor detecting the predetermined motion threshold.

6. The pet toy according to claim 1, wherein
the stem is detachably attached to the base.

7. The pet toy according to claim 6, wherein
the stem has an elongated body that is detachably fixed to the base at a location adjacent to the outlet.

8. The pet toy according to claim 1, wherein
the base includes a plurality of ridges disposed between the arcuate bottom and the top of the base.

9. The pet toy according to claim 8, wherein
the top of the base includes a tip, the tip having the outlet of the fluid emitter.

10. The pet toy according to claim 1, wherein
the reservoir is removably attached to the base at the arcuate shaped bottom.

11. The pet toy according to claim 10, wherein
the reservoir partially defines the arcuate shaped bottom of the base when the reservoir is attached to the base.
